(19) United States
(12) Patent Application Publication
(10) Pub. No.: US 2022/0152868 A1
(43) Pub. Date: May 19, 2022

(54) SYSTEM FOR APPLYING A BUILDING MATERIAL

(71) Applicant: SIKA TECHNOLOGY AG, Baar (CH)

(72) Inventors: Gary BOON, Dubai (AE); Didier LOOTENS, Küsnacht (CH); Maxime LIARD, Zürich (CH); Lolita HAUGUEL, Zürich (CH)

(73) Assignee: SIKA TECHNOLOGY AG, Baar (CH)

(21) Appl. No.: 17/439,462

(22) PCT Filed: Mar. 9, 2020
(86) PCT No.: PCT/EP2020/056257

§ 371 Date: Sep. 15, 2021

(30) Foreign Application Priority Data
Mar. 15, 2019 (EP) 19163218.1

(51) Int. Cl. B28B 1/00; B28C 5/12; B28C 7/02; E04G 21/04

(52) U.S. Cl. CPC B28B 1/001; B28C 5/1292; B33Y 30/00; E04G 21/0418; B28C 7/024

(57) ABSTRACT

A system for applying a building material including: a mixing device for mixing individual components of the building material into a curable building material; a pressure head which can be moved in at least one spatial direction and by means of which the workable building material can be applied; a delivery line, with which the curable building material can be conveyed from the mixing device to the pressure head; at least one delivery device for delivering the curable building material from the mixing device through the delivery line to the pressure head; a feed device, which is designed in such a manner that at least two separate components of the building material can be fed via at least two separate inlets into the mixing device, more particularly into a mixing chamber of the mixing device.

### TECHNICAL FIELD

The invention relates to a system for application of a building material and to the use of the system for producing three-dimensional objects from curable building materials, in particular from mineral binders or mineral binder compositions, in particular from concrete and/or mortar compositions.

### PRIOR ART

The production of shaped bodies by generative manufacturing processes is increasingly gaining importance in all fields of technology. The term “generative manufacturing process” or “generative manufacturing” refers to processes in which a three-dimensional object or a shaped body is produced by targeted three-dimensional deposition, application and/or solidification of material.

The deposition, application and/or solidification of the material is, in particular, carried out with the aid of a data model of the object to be produced and in particular in layers. In the generative manufacturing process, each object is typically produced from one or more layers. To manufacture an object, it is usual to employ a shapeless material (e.g. liquids, powders, granules, etc.) and/or a shape-neutral material (e.g. tapes, wires) which is, in particular, subjected to chemical and/or physical processes (e.g. melting, polymerization, sintering, curing). Generative manufacturing processes are also referred to as, inter alia, “additive manufacturing processes”, “additive manufacturing” or “3D printing”.

In the building sector, attempts have likewise been made for some time to produce geometrically demanding building components such as concrete elements by generative processes.

This is possible to a certain degree by means of appropriate apparatuses. Thus, for example, WO 2013/064826 A1 discloses a process and an apparatus for application of cement-based materials. Here, liquid cement-based material is applied by means of a movable robot arm to an intended place. A disadvantage of such systems is that the building material is often not sufficiently constant in respect of various properties, in particular in respect of mixing of components. As a result, irregularities can occur in a structure produced using the building material.

In general, the physical and chemical properties of mineral binder compositions greatly increase the difficulty of generative production of objects or shaped bodies from such binder compositions. As has been found, this is, in particular, attributable to the fact that the properties of mineral binder compositions in the processable state, both during the curing process and also in the cured state, are strongly influenced by ambient conditions and the apparatus in the production and application.

In addition, the cured building material composition has to meet other requirements, depending on the objects to be produced. For example, it can be necessary to control the flow properties, the kinetics and the shrinkage behaviour during the setting and curing process or the strength and surface quality after curing in order to produce an object having the desired properties.

Systems known hitherto for the generative production of objects from curable building materials are not completely convincing or they are complex in terms of construction and operation.

For this reason, there continues to be a need for new and improved solutions which preferably overcome the abovementioned disadvantages.

### BRIEF DESCRIPTION OF THE INVENTION

The present invention therefore addresses the problem of providing improved systems for the generative production of shaped bodies. The systems should, in particular, allow efficient, reliable and very flexible production of shaped bodies from curable building materials, in particular mineral binder compositions. This should if possible be combined with a very low outlay in terms of apparatus and be as inexpensive as possible.

It has surprisingly been found that the problem addressed by the invention can be solved by a system for application of a curable building material according to claim 1.

As has been found, objects can be produced from curable building materials, for example from mineral binder compositions, in an efficient, reliable and flexible way by means of such a system, which can be kept relatively simple in terms of apparatus. Owing to the limited apparatus required, the costs for the systems according to the invention can be kept relatively low.

It has surprisingly been found that objects which have a good quality in terms of strength and nature of the surface can nevertheless be produced by such systems. The systems are also universally usable and can if required be used for application of a wide variety of curable building materials, e.g. mortar or concrete compositions.

This could be attributable to the fact that a feed device is present, by means of which at least two separate components of the building material can be introduced into the mixing apparatus via at least two separate inlets. The composition of the curable building material can therefore be adapted at any time and flexibly.

In addition, by way of configured control units and/or optional measuring units, the system can be expanded relatively simply for a variety of uses.

Further aspects of the invention are subject matter of further independent claims. Particularly preferred embodiments of the invention are subject matter of the dependent claims.

In a first aspect, the invention provides a system for application of a curable building material, comprising:
a mixing apparatus for mixing individual components of the building material to give a curable building material in the setting state;
a printing head which is movable in at least one direction in space and by means of which setting building material can be applied, in particular at a predefined position;
a transport conduit by means of which setting building material can be conveyed from the mixing apparatus to the printing head;
at least one transport device for transporting setting building material from the mixing apparatus through the transport conduit to the printing head;
a feed device which is configured so that at least two separate components of the curable building material can be introduced via at least two separate inlets into the mixing apparatus, in particular into a mixing chamber of the mixing apparatus.

For the present purposes, a “building material” is a material which comprises or consists of at least two separate components. The building material serves, in particular, for the erection of three-dimensional objects which can be, for example, constituents of building works and/or buildings.

A “curable building material” is a building material which is typically flowable or liquefiable and after making-up, for example by addition of mixing water and/or by mixing of components, can cure as solid. The curable building material is, for example, reactive resins, a mineral binder, mineral binder compositions or mixtures thereof.

A “setting building material” is accordingly a curable building material in the setting or curing state, in which the setting process has been initiated, for example by addition of mixing water and/or a hardener.

Reactive resins are, in particular, liquid or liquefiable synthetic resins which cure by polymerization or polyaddition to give thermosets. For example, it is possible to use unsaturated polyester resins, vinyl ester resins, acrylic resins, epoxy resins, polyurethane resins and/or silicone resins.

The expression “mineral binder” refers, in particular, to a binder which reacts in the presence of water in a hydration reaction to give solid hydrates or hydrate phases. This can be, for example a hydraulic binder (e.g. cement or hydraulic lime), a latent hydraulic binder (e.g. slag), a pozzolanic binder (e.g. flyash) or a nonhydraulic binder (e.g. gypsum plaster or white lime).

A “mineral binder composition” is accordingly a composition containing at least one mineral binder. This in the present case contains, in particular, the binder, aggregates and optionally one or more admixtures. Aggregates present can be, for example, rock particle fractions, gravel, sand (in natural and/or processed (e.g. crushed) form) and/or fillers.

The mixing apparatus is, in particular, designed so that it can be operated continuously during the application of setting building material. This is in particular so that curable building material in the setting state can be provided continuously from the at least two separate components and can be conveyed via the transport conduit to the printing head.

The mixing apparatus is preferably designed so that an average residence time of the components of the curable building material in the mixing apparatus, in particular a dynamic mixer, is less than 10 s, more preferably less than 7 s, particularly preferably less than 4 s. The average residence time of the components of the curable building material in the mixing apparatus is for the present purposes the period of time for which a particle of the curable building material remains on average in the mixing apparatus, from inlet to outlet.

The mixing apparatus preferably comprises a dynamic mixer. In the present document, a “dynamic mixer” is a mixing apparatus which comprises movable elements and is suitable for mixing solid and/or liquid constituents by movement of the movable elements. Particularly effective mixing of the components can be achieved by means of a dynamic mixer and it is possible to introduce energy into the curable building material during the mixing operation. This is particularly advantageous when the curable building material comprises a mineral binder composition.

However, it is in principle also possible to use a static mixer. A static mixer is a mixer in which mixing is effected solely by the flow movement of the fluids moving through the mixer without moving elements being present. A static mixer typically has flow-influencing elements in a tubular mixing chamber. The flow-influencing elements can divert, divide and/or combine the stream of material, as a result of which mixing is achieved.

The printing head is advantageously spatially separated and/or at a distance from the mixing apparatus, in particular a dynamic mixer. This is particularly the case for all dynamic mixers of the system.

The mixing apparatus, in particular a dynamic mixer, is preferably arranged in such a way that during operation a position of the printing head relative to the mixing apparatus, in particular a dynamic mixer, is changed on movement of the printing head. This is in particular the case for all dynamic mixers.

The mixing apparatus, in particular a dynamic mixer of the mixing apparatus, is preferably arranged in a stationary manner. As a result, this does not have to be moved together with the moving printing head during operation. Preference is given to all dynamic mixers being arranged in a stationary manner.

In a preferred embodiment, the mixing apparatus, in particular a dynamic mixer, is not arranged on the movable printing head and/or no mixing apparatus, in particular no dynamic mixer, is arranged on the movable printing head.

As a result, the mixing apparatus, in particular a dynamic mixer, does not also have to be moved during movement of the printing head. This in turn has the advantage that the mechanics for movement of the printing head can be made simpler, which reduces both the complication of the apparatus and the costs.

However, it is in principle also possible to install the mixing apparatus at least partly in the region of the moving printing head.

In a particular embodiment, the mixing apparatus comprises a dynamic mixer and a static mixer, with the static mixer preferably being arranged in the transport conduit and/or in the printing head. The dynamic mixer is preferably arranged at a distance from the static mixer in the flow direction. In particular, the dynamic mixer is arranged upstream of the static mixer.

In this way, the curable building material can be mixed again in the static mixer after initial mixing in the dynamic mixer. If the static mixer is arranged directly before the mixing head or in the mixing head itself, this can be effected immediately before exit of the setting building material from the printing head, which can improve the homogeneity of the setting building material exiting from the printing head.

In addition, a static mixer in the region of the printing head has the advantage that it can be integrated into the transport conduit or be present as constituent thereof, as a result of which the region of the printing head can be kept compact. In addition, static mixers are typically relatively light compared to dynamic mixers, so that the mechanics for moving the printing head have to be less robust, which reduces both the complication of the apparatus and the costs.

In particular, a device for influencing the chemical and/or physical properties of the setting building material is additionally present. In particular, this is a device for influencing the physical properties of the setting building material. The device for influencing the chemical and/or physical properties is preferably arranged in or on the transport conduit and/or the printing head, especially in or on the printing head.

The flow properties and/or the setting behaviour, for example, of the setting building material can be controlled and/or adapted in this way.

For example, an inlet nozzle for introduction of an admixture into the setting building material can be present in the transport conduit and/or in the region of the printing head. The admixture serves here in particular for influencing the chemical and/or physical properties of the setting building material. The admixture is preferably selected from among a retarder, a rheological auxiliary and/or a plasticizer. It is preferably a retarder, a rheological auxiliary or a plasticizer for mineral binder compositions.

Retarders are, for example, selected from the list consisting of hydroxycarboxylic acids, sucrose and/or phosphates. This is particularly the case when the curable building material is a mineral binder or a mineral binder composition.

Possible plasticizers are, for example, lignosulfonates, sulfonated naphthalene-formaldehyde condensates, sulfonated melamine-formaldehyde condensates, sulfonated vinyl copolymers, polyalkylene glycols having phosphonate groups, polyalkylene glycols having phosphate groups, polycarboxylates, polycarboxylate ethers, comb polymers having polyalkylene oxide side chains and anionic groups in the polymer backbone, with the anionic groups being selected, in particular, from among carboxylate groups, sulfonate groups, phosphonate groups or phosphate groups, or mixtures of the plasticizers mentioned.

For the purposes of the present document, a “rheological auxiliary” is a substance which can change the rheological properties of the setting building material, in particular of a water-containing mineral binder composition; in particular, it increases the viscosity, the yield point and/or the thixotropy.

For example, the rheological auxiliary is selected from the group consisting of modified starches, modified celluloses, microbial polysaccharides and/or mineral thickeners. The modified starch is preferably a starch ether, in particular hydroxypropyl starch, carboxymethyl starch or carboxymethyl hydroxypropyl starch. The modified cellulose is preferably methyl cellulose, ethyl cellulose, hydroxymethyl cellulose, hydroxyethyl cellulose or methyl hydroxyethyl cellulose.

The flow, setting or curing behaviour of curable building materials in the form of mineral binder compositions can be set particularly readily by means of the abovementioned representatives of admixtures. The rheological auxiliary is particularly suitable for ensuring the dimensional stability of the water-containing binder composition and giving an applied layer sufficient strength to bear one or more of further layers without significantly changing the shape. The use of retarders can be advantageous since the processing time of the water-containing binder composition is increased thereby.

In an advantageous embodiment, the inlet nozzle is located upstream of any static mixer present and/or in the region of an outlet opening of the printing head. In this way, the admixture can be introduced in an effective way into the setting building material and mixed with the latter if required.

However, an admixture can also be present as constituent of a component and/or as separate component during mixing of the at least two components.

It can also be advantageous for a device for aeration and/or deaeration of the setting building material to be present. This is, in particular, an air introduction system, a vacuum treatment device and/or a vibration device. The device for aeration and/or deaeration is preferably located on or in the transport conduit and/or on or in the printing head.

An aerating and/or deaerating apparatus in particular enables the flow properties of the setting building material to be controlled and/or changed during application. This can, for example, be useful in order to keep the flow properties constant under changing ambient conditions and/or adapt the flow properties for the respective section of the object to be produced.

In a further advantageous embodiment, an apparatus for changing the temperature of the setting building material is present. It is, in particular, a heating element and/or a cooling element. The temperature changing apparatus is preferably present on or in the transport conduit and/or on or in the printing head.

A temperature changing apparatus enables the temperature of the setting building material to be controlled and/or changed during application. This can, for example, be useful in order to control and/or modify the solidification and/or curing processes. For example, the temperature of the setting building material can be adapted in the event of changing ambient conditions. Likewise, the solidification and/or curing processes for various sections of the object to be produced can be altered by means of adaptation of the temperature.

The feed device is advantageously configured so that a solid component of the building material can be introduced into the mixing apparatus via a first inlet and a liquid component can be introduced via a second inlet. For example, a solid component of a mineral binder composition, which comprises, for example, a mineral binder and aggregates in solid form, can be introduced via the first inlet into the mixing apparatus, while a liquid component, e.g. water, can be introduced separately from the first component via the second inlet. In this way, the mixing ratio of the two components can be adapted at any time.

In a further advantageous embodiment, the feed device is configured so that at least three separate components of the building material can be introduced into the mixing apparatus via at least three separate inlets on the mixing apparatus. This enables the composition of the curable building material to be controlled even better. For example, a solid component of a mineral binder composition comprising, for example, a mineral binder and aggregates in solid form can be introduced via the first inlet into the mixing apparatus. A second component, which for example comprises fibres, can then be introduced separately through the second inlet into the mixing apparatus, while the third component, e.g. water, can be introduced separately from the other two components via the third inlet into the mixing apparatus. The mixing ratio of all three components can thus be adapted at any time.

In principle, four, five or even more separate inlets can also be present. In this way, the curable building material can be modified in virtually any way in respect of its composition.

If the system comprises an inlet nozzle, the feed device advantageously has a further inlet which, for example, corresponds with an admixture reservoir and also has a further outlet which is connected to the inlet nozzle.

For the purposes of the present document, “fibres” are materials whose ratio of length to diameter or length to equivalent diameter is at least 10:1. This ratio is also referred to as shape factor.

For the purposes of the present document, the “equivalent diameter of a fibre” is the diameter of a circle which has the same area as the cross-sectional area of a fibre which does not have a round cross section.

The feed device has, in particular, at least one or more metering devices. The at least one metering device is configured so that one or more of the components of the curable building material can be metered in a controlled manner and/or at a defined addition rate into the mixing apparatus.

It is particularly advantageous for each inlet of the mixing apparatus to have a separate and individually controllable metering device.

If the system comprises an inlet nozzle, the feed device advantageously has a further metering device which is configured in such a way that an admixture can be introduced in a controlled manner and/or at a defined addition rate into the inlet nozzle.

For example, the metering device is a gravimetric metering device. Such metering devices have in the present case been found to be readily handleable but nevertheless precise.

The provision of a gravimetric metering device offers the advantage that a component, in particular a solid component, can be introduced in precise amounts into the system. A quality of the building material can be kept constant in this way.

In an illustrative further development, the metering device comprises a funnel and a transport facility. The transport facility can, in particular, be configured as transport screw or conveyor belt.

The provision of a funnel and a transport facility has the advantage that it makes it possible to use large units of a component of the building material, for example large containers or sacks (known in technical language as “Big Bag”). For example, such large units can be hung up in the one vessel and the contents can be supplied via a funnel to a transport facility. The funnel has the advantage that it can be utilized as store and can thus bridge a period of time during which the containers of the first constituent of the first component of the building material are exchanged. The transport facility enables, for example, a first component to be supplied to the metering device.

In an advantageous embodiment, the transport device is present in the mixing apparatus, in the transport conduit and/or in the printing head or the transport device is a constituent of these elements. This allows a compact construction. However, arrangements of the transport device are also possible.

In particular, a transport element is present in the region of the printing head and/or is integrated into the latter and is, in particular, moved together with movement of the printing head. The conveying power can be kept constant particularly effectively in this way.

Very particular preference is given to two separate transport devices being present, with a first transport device preferably being integrated into the mixing apparatus while the second transport device is integrated into the mixing head. This results in particularly uniform transport of the setting building material.

As transport device, use is made in particular of a pump, for example a transport screw.

In an illustrative embodiment, the mixing apparatus comprises a stirrer shaft which is equipped on a first section with stirring elements and on which a transport element is arranged on a second section.

It has been found that firstly the components of the curable building material can be mixed in this way in the mixing apparatus and at the same time can be conveyed in mixed form out of the mixing apparatus.

In an advantageous further development, the stirring elements are configured as pins. In a further advantageous embodiment, the stirring elements have an external thread so that the stirring elements can be screwed into depressions having internal threads on the stirrer shaft.

In an illustrative further development, the transport element is configured as transport screw.

In an illustrative further development, the first section of the stirrer shaft is arranged in a first region of a drum of the mixer in which the drum has at least two inlets. In addition, the second section of the stirrer shaft is arranged in a second region of the drum in which the drum has an outlet.

In an illustrative further development, the transport element can be pulled off from the stirrer shaft in the direction of an axis of the stirrer shaft.

In an illustrative further development, the transport element comprises a fastening element for locking the transport element onto the stirrer shaft.

In an illustrative further development, a drum of the mixer is made in one piece and/or in the form of a tube.

In particular, the system of the invention has at least one vessel in which at least one of the two components of the building material can be stored. The system of the invention particularly preferably has at least two vessels in which the at least two components of the building material can be stored spatially separately.

Furthermore, the system of the invention can have a reservoir for an admixture. An admixture which is, for example, added via the inlet nozzle can be stored in such a reservoir.

However, it is also possible to supply one or more of the components and/or an admixture via a transport conduit from an external source.

The one or more vessels preferably correspond with the feed device, so that a component present in a vessel can be introduced directly via a dedicated inlet into the mixing apparatus.

In such an arrangement, the system of the invention can, after charging of the vessels and/or connection to a transport conduit, produce a defined part or the entirety of the object to be produced, essentially without further intervention.

It is further preferred for a measuring unit to be present, by means of which a chemical and/or physical property of the curable building material can be determined in the mixing apparatus, in the transport conduit, in the printing head and/or after discharge from the printing head.

The determination of a chemical and/or physical property of the setting building material enables this to be assessed in respect of its specific state. This makes it possible for, for example, the ratio of the components, the speed at which the setting building material is conveyed and/or the addition rate of an admixture to be adapted as a function of the chemical and/or physical property if required. Overall, a more constant quality of the curable building material can be achieved thereby and/or the curable building material can be adapted or changed in a targeted manner for specific sections of the object to be produced.

The measuring unit is, in particular, configured so that a measurement frequency for determining the chemical and/or physical property is >0.01 Hz, preferably, >0.1 Hz, particularly preferably >1 Hz, very particularly preferably >10 Hz. The chemical and/or physical properties of the setting building material can be determined at regular intervals or continuously in this way.

The measuring unit is particularly preferably designed so that the determination of the chemical and/or physical property can be carried out during application of the building material, in particular in real time.

The measuring unit is preferably arranged in the mixing apparatus, in the transport conduit and/or in the printing head.

The measuring apparatus particularly preferably comprises a temperature measuring apparatus, a pressure measuring apparatus, a moisture measuring apparatus, a measuring apparatus for determining the electrical conductivity, a penetrometer, an ultrasonic transducer and/or a rheometer. Appropriate measuring apparatuses are known per se to a person skilled in the art.

Essentially all relevant properties of the setting building material can thus be determined. In particular, an outlet which is controllable in respect of the size of the through-opening is present on the printing head, with the outlet preferably being completely closable. This can occur, for example, by means of an openable and closable valve, with the valve being able, in particular, to be opened and closed pneumatically and/or electromechanically. The throughput rate during application of the setting building material can be adapted in a targeted manner in this way.

In particular, the system of the invention has a control unit. The control unit is, in particular, designed so that at least part of the apparatuses and units present in the system can be controlled and/or regulated in a controlled manner. The term “regulate” or “regulated” refers, in particular, to setting of a predetermined intended value and maintenance thereof for a defined period of time.

The control unit has, in particular, a processor, a data store, an interface for receiving data from any measuring apparatuses present and/or an interface for controlling apparatuses of the system of the invention.

The apparatuses and units present in the system are preferably connected via data lines, control lines and/or wireless communication systems to the control unit.

The controllable devices are, if present, the movable printing head, the controllable outlet opening, the mixing apparatus, the transport device, the inlet nozzle and/or the feed device, in particular.

A data model which represents at least part of the object to be produced or the entire object to be produced is preferably stored in the control unit. In addition, the control unit is advantageously configured so that parameters and/or intended values to be adhered to during application can be set down with reference to the data model.

Here, different parameters and/or intended values are preferably set down for various sections of the object to be produced and/or or said parameters and/or intended values are present in the control unit. The parameters or intended values are, for example, the rate at which the transport device transports, the size of the opening of the outlet nozzle, the mixing ratio of the at least two components, the rate of addition of the admixture via the inlet nozzle, the pressure of the setting building material, the viscosity of the setting building material, the temperature of the setting building material and/or the ambient temperature of the region in which the object to be produced is produced.

Furthermore, it can be advantageous for one or more properties of the at least two components of the curable building material, for example the chemical composition, a previously determined yield point and/or a previously determined viscosity, to be stored or be able to be stored in the control unit.

The control unit is preferably configured so that the size of the throughput opening of the controllable outlet is controlled as a function of the structure of the object to be produced. In this way, the structure to be produced can be produced more precisely and in a more controlled manner.

In particular, the control unit is configured so that the conveying power of the transport device is controlled and/or regulated, in relation to a chemical and/or physical property of the curable building material which is determined with the measuring unit, in particular in relation to a pressure of the curable building material in the transport conduit and/or in the printing head.

This enables an essentially constant pressure to be maintained in the transport conduit and/or the printing head. Accordingly, it is thus achieved that a defined flow of curable material exits from the printing head in the case of a given outlet opening so that the precision in the production of the object to be produced is improved.

It can also be advantageous for the control unit to be configured so that the conveying power of the transport device is regulated in relation to a fill level of the components in one or more vessels. This makes it possible to avoid the system running empty and air being introduced.

It can be further advantageous for the control to be configured so that, using the feed device, an addition rate of at least one component of the building material, can be regulated or is carried out as a function of the chemical and/or physical property of the curable building material and/or as a function of the size and/or structure of the object to be produced. The composition and nature of the curable building material can be kept constant and/or adapted in a targeted manner in this way. The control is advantageously configured so that the addition rate can be or is carried out during application of the curable building material, in particular in real time.

In particular, a control unit is present which is configured so that a volume flow of the curable building material exiting from the printing head is carried out as a function of the size and/or structure of an object to be produced using the curable building material.

The control unit is preferably configured so that the transport device is carried out as a function of a chemical and/or physical property of the curable building material and/or as a function of the size and/or structure of an object to be produced using the curable building material.

Furthermore, the control unit is, in particular, configured so that an addition rate of an admixture, in particular a rheological auxiliary and/or a retarder, through the inlet nozzle is controlled as a function of a chemical and/or physical property of the curable building material and/or as a function of the size and/or structure of an object to be produced using the curable building material.

It is likewise advantageous for the control unit to be configured so that the application of the setting building material is controlled and/or regulated with regard to the ambient temperature of a region in which the object to be made is produced. For example, the addition rate of an admixture can be controlled and/or regulated by means of the inlet nozzle, the conveying power of the transport device and/or the addition rate of at least one component of the building material as a function of the ambient temperature of a region in which the object to be made is produced.

Furthermore, preference is given to the control unit being configured so that the transport rate and the movement of the printing head are matched to one another.

In a particularly advantageous embodiment:
a first component of the building material is present in solid form and comprises a mineral binder and optionally aggregates, in particular gravel, sand, rock particle fractions and/or fillers, and optionally a concrete and/or mortar admixture;
a second component of the building material is present in liquid form and comprises water;
an optional third component comprising a plasticizer;
an admixture which can be added via the inlet nozzle and preferably comprises a plasticizer, a rheological auxiliary and/or a retarder is optionally present;

where the components and optionally the are present in vessels which are spatially separated from one another and are constituents of the feed device and/or communicate with the latter.

The first component is particularly preferably a dry mineral binder composition comprising cement and mineral fillers, where the binder composition comprises at least one setting accelerator based on aluminium sulfate, at least one superplasticizer based on a polycarboxylate ether and at least one rheological auxiliary, where the polycarboxylate ether has, assuming that all carboxylic acid groups are present as free acid, at least 1 mmol, in particular at least 1.2 mmol, especially at least 1.8 mmol, of carboxylic acid groups per gram of dry polycarboxylate ether.

In the present document, a “dry mineral binder composition” is a free-flowing mineral binder composition having a moisture content of less than 0.5% by weight.

In the present document, a “water-containing mineral binder composition” is a mineral binder composition which has been mixed with water, in particular in fluid form. Accordingly, a “water-containing mineral binder composition” is a curable building material in the setting state.

In the present document, a “polycarboxylate ether” is a comb polymer comprising a backbone of hydrocarbons with carboxylic acid groups or salts thereof bound thereto and likewise polyalkylene glycol side chains covalently bound to the backbone. The side chains are, in particular, bound via ester, ether, imide and/or amide groups to the polycarboxylate backbone.

The amount of carboxylic acid groups in the polycarboxylate ether is reported as millimol of carboxylic acid groups in one gram of the polycarboxylate ether (mmol/g). For this purpose, any salts of the carboxylic acids present are counted as carboxylic acid groups and the weight of the polycarboxylate ether in unneutralized form is used. Carboxylic esters are not counted as carboxylic acid groups in this case, even when they are present in latent form, i.e. when they can be hydrolyzed in an alkaline medium at pH 12.

In the present document, “dimensional stability” is a materials property such that the material after shaping has individual dimensions which are altered by not more than 10%, as long as no external force apart from gravity acts on the shaped material.

In the present document, “sag resistance” refers to any strength which the curable material has after application but before curing.

As cement, it is possible to use any available type of cement or a mixture of two or more types of cement, for example the cements classified under DIN EN 197-1: Portland cement (CEM I), Portland composite cement (CEM II), blast furnace slag cement (CEM III), pozzolanic cement (CEM IV) and composite cement (CEM V). Of course, cements which are produced according to an alternative standard, for example the ASTM standard or the Indian standard, are equally suitable. Preference is given to Portland cement CEM I or CEM II in accordance with DIN EN 197-1. Particular preference is given to Portland cement CEM I 42.5 or CEM I 52.5. Such cements give good strengths and good processability.

For the production of white or coloured shaped bodies, it is advantageous to use a white cement CEM I or CEM II.

The dry mineral binder composition advantageously also contains at least one latent hydraulic or pozzolanic binder, in particular metakaolin and/or silica dust (amorphous SiO₂). The latent hydraulic or pozzolanic binder is preferably present in an amount of from 0.1 to 10% by weight, in particular from 0.5 to 5% by weight, in the binder composition. These additives can improve the processability of the aqueous binder composition and the strength of the cured binder composition.

The dry mineral binder composition contains mineral fillers. Fillers are chemically inert solid particulate materials and are available in various shapes, sizes and as different materials which range from very fine sand particles through to large coarse stones. All fillers which are customarily used for concrete and mortar are in principle suitable.

Examples of particularly suitable fillers are rock particle fractions, gravel, sand, in particular silica sand, limestone sand and slag sand, comminuted stones, calcined pebbles or lightweight fillers such as expanded clay, expanded glass, foam glass, pumice, pearlite and vermiculite. Further advantageous fillers are fine or very fine fillers such as ground limestone or dolomite, aluminium oxide, silica dust, quartz flour or ground steel slag without or with only weakly latently hydraulic reactivity.

Preferred fillers are selected from the group consisting of silica sand, quartz flour, limestone sand, ground limestone and ground steel slag. The filler preferably comprises at least one finely ground crystalline filler, in particular limestone. This can promote early strength development of the binder composition mixed with water.

The particle size of the fillers depends on the use and is in the range from 0.1 μm to 32 mm and more. Preference is given to mixing different particle sizes in order to set the properties of the binder composition is an optimal way. It is also possible to mix fillers composed of different materials. The particle size can be determined by means of sieve analysis.

Preference is given to fillers having particle sizes of not more than 8 mm, preferably not more than 5 mm, even more preferably not more than 3.5 mm, most preferably not more than 2.2 mm, in particular not more than 1.2 mm or not more than 1.0 mm.

The particle size is determined particularly by the planned layer thickness of the applied layers in 3D printing or the generative manufacturing process. Thus, a maximum particle size of the fillers is appropriately not larger than the layer thickness when being applied.

The dry mineral binder composition preferably contains from 20 to 40% by weight, in particular from 22 to 36% by weight, based on the total weight of the dry binder composition, of fine fillers having a particle size of less than 0.125 mm.

Suitable fillers having a small particle size are, in particular, fine silica sands, quartz flour, ground calcium carbonate or ground steel slag.

The mineral binder composition preferably contains from 1 to 10% by weight, more preferably from 2 to 5% by weight, of ground calcium carbonate having a particle size of less than 0.01 mm. The fine calcium carbonate improves the processability of the binder composition which has been mixed with water and can increase the strength development of the binder composition.

Aqueous binder compositions having such particle sizes are readily conveyable, can be readily mixed with the aqueous accelerator in the continuous mixer and after application give a very homogeneous surface.

In specific uses, it is also possible to use fillers having particle sizes of up to 32 mm, more preferably up to 20 mm, most preferably up to 16 mm.

The mineral fillers are preferably present in an amount of from 45 to 85% by weight, in particular from 50 to 80% by weight, based on the total weight of the dry mineral binder composition.

The dry mineral binder composition preferably contains an accelerator based on aluminium sulfate. The accelerator is a freely-flowing powder and advantageously contains at least 30% by weight, preferably at least 35% by weight, more preferably at least 40% by weight, of aluminium sulfate, calculated as aluminium sulfate hydrate Al₂(SO₄)₃.16H₂O.

The accelerator can advantageously contain further constituents such as amino alcohols, alkali metal nitrates and alkaline earth metal nitrates, alkali metal nitrites and alkaline earth metal nitrites, alkali metal thiocyanates and alkaline earth metal thiocyanates, alkali metal halides and alkaline earth metal halides, alkali metal carbonates, glycerol, glycerol derivates, further aluminium salts, aluminium hydroxides, alkali metal hydroxides and alkaline earth metal hydroxides, alkali metal silicates and alkaline earth metal silicates, alkali metal oxides and alkaline earth metal oxides or alkali metal and alkaline earth metal salts of formic acid or mixtures thereof in addition to the aluminium sulfate.

In an especially preferred binder composition, the accelerator comprises at least 90% by weight, in particular at least 95% by weight, of aluminium sulfate hydrate or is aluminium sulfate hydrate.

The binder composition is preferably free of amino alcohols. Amino alcohols have an intensive unpleasant odour, can be harmful to health and can lead to uncontrolled stiffening of the binder composition which has been mixed with water.

The accelerator based on aluminium sulfate is preferably present in an amount of from 0.1 to 2% by weight, more preferably from 0.3 to 1.5% by weight, in particular from 0.4 to 1.0% by weight, based on the total weight of the dry mortar mixture.

Such a metered addition of the accelerator leads to rapid strength development of the binder composition which has been mixed with water, without limiting the processability for the pressure operation, in particular in combination with polycarboxylate ethers.

The binder composition comprises at least one superplasticizer based on a polycarboxylate ether. The at least one polycarboxylate ether contains carboxylic acid groups in the form of free, i.e. unneutralized, carboxylic acid groups and/or in the form of their alkali metal and/or alkaline earth metal salts. Preference is given to polycarboxylate ethers which do not have any further anionic groups in addition to the carboxylic acid groups.

Further preferably polycarboxylate ethers whose side chains comprise at least 80 mol %, preferably at least 90 mol % and especially preferably consist of 100 mol % of ethylene glycol units.

The side chains preferably have an average molecular weight Mw in the range from 500 to 10 000 g/mol, preferably from 800 to 8 000 g/mol, especially preferably from 1 000 to 5 000 g/mol. It is also possible for side chains having different molecular weights to be present in the polycarboxylate ether.

Special preference is given to polycarboxylate ethers which is made up of methacrylic acid and/or acrylic acid units and methylpolyalkylene glycol methacrylates or acrylates. The at least one polycarboxylate ether preferably has an average molecular weight Mw of from 8 000 to 200 000 g/mol, in particular from 10 000 to 100 000 g/mol, measured relative to a polyethylene glycol standard.

Such polycarboxylate ethers are particularly suitable for making good processability of the binder composition possible, even at a low water content. A low water content brings about high strength of a cured shaped body.

In combination with the accelerator based on aluminium sulfate, such polycarboxylate ethers have a particularly good effect as agent for controlling the stiffening of the aqueous binder composition.

The at least one polycarboxylate ether can be introduced as aqueous solution into the binder composition, for example by spraying onto the fillers before mixing with the mineral binder.

The at least one polycarboxylate ether is preferably present as polymer powder in the dry binder composition.

In a preferred embodiment of the invention, the at least one polycarboxylate ether has a block or gradient structure. In the present document, a “polycarboxylate ether having a block or gradient structure” is a polymer in which the monomer units are present in a nonrandom sequence, i.e. the sequence is not obtained coincidentally. In the polycarboxylate ether having a block or gradient structure, at least one section comprises monomer units comprising polyalkylene glycol side chains and no or barely any monomer units having carboxylate groups and at least one section comprises monomer units having carboxylate groups and no or barely any monomer units having polyalkylene glycol side chains. Such block or gradient polymers therefore have sections having a high density of anionic groups and sections which contain no or only few anionic groups.

Polycarboxylate ethers having a block or gradient structure surprisingly develop their action as plasticizer very quickly. They are therefore particularly well suited for uses in which the mixing time of binder composition and water is very short, in particular for continuous mixing.

In addition, polycarboxylate ethers having a block or gradient structure result in a low viscosity of the binder composition; this improves the pumpability.

Likewise surprisingly, the plasticizing effect of the polycarboxylate ethers having a block or gradient structure persists for only a few minutes in the binder compositions of the invention, which is advantageous for 3D printing because it enables good processability of the aqueous binder composition immediately after mixing and good sag resistance after application to be achieved.

The at least one polycarboxylate ether is preferably present in an amount of from 0.02 to 5% by weight, preferably from 0.05 to 4% by weight, in particular from 0.1 to 3% by weight, calculated as dry polymer and based on the total weight of the dry binder composition.

The metered addition of the at least one polycarboxylate ether into the binder composition is advantageously matched to the respective printing task. Thus, the printing parameters such as, typically, the desired height of the shaped body, the thickness of the applied layers, the printing speed and the ambient temperature to be expected are advantageously measured before printing and the optimal amount of the polycarboxylate ether in the binder composition is subsequently determined by means of values based on experience, tables and/or a computer program.

The total amount of the polycarboxylate ether is advantageously provided in the dry binder composition.

However, it can also be advantageous, particularly in the case of small amounts being used and/or when the printing parameters are variable, especially due to temperature fluctuations, delay times or additional manufacturing steps during shaping, for only part of the polycarboxylate ether to be present in the dry binder composition and a further part, in each case matched to the prevailing printing conditions, to be added during or after mixing with water.

The further part of the polycarboxylate ether is advantageously added together with the mixing water in a continuous mixing process.

The binder composition can in this way be produced in a large amount, which is advantageous, and matching to the respective printing conditions is effected simply and inexpensively on the building site.

The binder composition preferably contains at least one organic and/or inorganic rheological auxiliary.

Suitable rheological auxiliaries are, in particular, modified starches, amylopectin, modified cellulose, microbial polysaccharides, galactomannans, alginates, tragacanth, polydextrose, superabsorbents or mineral thickeners.

The rheological auxiliary is preferably selected from the group consisting of modified starches, modified celluloses, microbial polysaccharides, superabsorbents and mineral thickeners.

The total amount of rheological auxiliaries is preferably from 0.01 to 5% by weight, based on the total weight of the dry binder composition.

The modified starch is preferably a starch ether, in particular hydroxypropyl starch, carboxymethyl starch or carboxymethyl hydroxypropyl starch. The modified starch is preferably present in an amount of from 0.01 to 2% by weight, based on the total weight of the dry binder composition.

The modified cellulose is preferably methyl cellulose, ethyl cellulose, hydroxymethyl cellulose, hydroxyethyl cellulose or methyl hydroxyethyl cellulose and is preferably present in an amount of from 0.01 to 2% by weight, based on the total weight of the dry binder composition.

The microbial polysaccharide is preferably welan gum, xanthan gum or diutan gum and is preferably present in an amount of from 0.01 to 0.1% by weight, based on the total weight of the dry binder composition.

The superabsorbent is preferably selected from the group consisting of polyacrylamide, polyacrylonitrile, polyvinyl alcohol, isobutylene-maleic anhydride copolymers, polyvinylpyrrolidone, homopolymers and copolymers of monoethylenically unsaturated carboxylic acids such as (meth)acrylic acid, crotonic acid, sorbic acid, maleic acid, fumaric acid, itaconic acid, preferably polyacrylic acid, which can be partially or completely neutralized, and copolymers and terpolymers of the abovementioned monoethylenically unsaturated carboxylic acids with vinylsulfonic acid, (meth)acrylamidoalkylsulfonic acids, allylsulfonic acid, vinyltoluenesulfonic acid, vinylphosphonic acid, (meth)acrylamide, N-alkylated (meth)acrylamide, N-methylol(meth)acrylamide, N-vinylformamide, N-vinylacetamide, vinylpyrrolidone, hydroxyalkyl(meth)acrylate, ethyl acrylate, methyl acrylate, (meth)acrylic esters of polyethylene glycol monoallyl ethers, vinyl acetate and/or styrene.

The superabsorbent homopolymers and copolymers can be linear or branched, and the copolymers can be present as random copolymers or as block or gradient polymers. The homopolymers and copolymers are preferably additionally crosslinked.

The superabsorbent is preferably polyacrylic acid which can be partially or completely neutralized and is crosslinked.

If present, the superabsorbent is preferably present in an amount of from 0.01 to 0.5% by weight, in particular from 0.05 to 0.3% by weight, based on the total weight of the dry binder composition.

As mineral thickeners, it is possible to use, for example, specific silicates or clay minerals.

Preference is given to bentonites and sepiolite. The mineral thickener is preferably present in an amount of from 0.1 to 1% by weight, based on the total weight of the dry binder composition.

The binder composition preferably contains at least two, more preferably at least three, different rheological auxiliaries.

The rheological auxiliary is particularly suitable for ensuring the dimensional stability of the water-containing binder composition and giving an applied layer sufficient sag resistance to support one or more further layers, without changing its shape significantly, before hydration of the cement commences.

Preferred combinations of two or more rheological auxiliaries are:
modified cellulose and microbial polysaccharide;
modified cellulose and superabsorbent;
microbial polysaccharide and superabsorbent;
microbial polysaccharide, superabsorbent and mineral thickener;
modified cellulose, microbial polysaccharide and superabsorbent;
modified cellulose, microbial polysaccharide, superabsorbent and mineral thickener.

The combination of two or more rheological auxiliaries enables different thickening properties of the rheological auxiliaries to be optimally matched to one another. This brings about good processability with good sag resistance of the water-containing binder composition.

Special preference is given to a combination of rheological auxiliaries which comprises at least one superabsorbent.

The superabsorbent additionally acts as agent for reducing shrinkage, which is particularly advantageous.

Preference is given to the binder composition additionally containing from 0.1 to 5% by weight, preferably from 0.5 to 3% by weight, of calcium sulfoaluminate, based on the total weight of the dry binder composition.

The calcium sulfoaluminate can, especially in the preferred amount, firstly increase the early strength development of the aqueous binder composition and at the same time reduce the shrinkage.

A higher content of calcium sulfoaluminate in the binder composition can reduce the final strength of a printed shaped body and increases the costs for the composition.

The shrinkage of the binder composition after application can surprisingly be reduced greatly by the specific combination of calcium sulfoaluminate and rheological auxiliary. Shrinkage can lead to formation of cracks in the shaped body produced. Cracks can reduce the durability of the printed structures and adversely affect the visual appearance.

The calcium sulfoaluminate is particularly advantageously a calcium sulfoaluminate cement.

The binder composition advantageously also contains at least one further additive for reducing shrinkage selected from the group consisting of glycols, polyglycols and water-storing materials, in particular porous stones, ground bricks and/or group set cement bodies.

The binder composition preferably also contains at least one antifoam, in particular selected from the group consisting of oil-based antifoams, in particular antifoams based on mineral oil, vegetable oil or white oil, which can contain a wax and/or hydrophobic silica, silicone-based antifoams which can, for example, be modified by alkoxylation or fluorination, alkyl esters of phosphoric or phosphonic acid, alkoxylated polyols, in particular ethoxylated diols, fatty acid-based antifoams, in particular monoglycerides and diglycerides of fatty acids, and alkoxylated fatty alcohols, and mixtures thereof.

The antifoam is preferably selected from the group comprising of ethoxylated 2,4,7,9-tetramethyl-5-decyne-4,7-diol, a combination of fatty alcohol alkoxylates and polysiloxane and a combination of mineral oil and a hydrophobic silica containing silicone oil.

The antifoam is preferably present in an amount of from 0.01 to 1% by weight, in particular from 0.1 to 0.8% by weight, based on the total weight of the dry binder composition.

The use of an antifoam is advantageous because the formation of air pores during mixing of the dry binder composition with water is prevented or reduced thereby. Air pores can interfere in the transport of the water-containing binder composition to the printing head and reduce the strength in the cured shaped body, and the pores also adversely affect the visual appearance of the shaped bodies.

Surprisingly, the antifoam additionally brings about a reduction in the shrinkage and thus crack formation in the cured shaped body.

The mineral binder composition can optionally also contain at least one further additive, for example a concrete admixture and/or a mortar admixture. The at least one further additive comprises, in particular, a plasticizer, a retarder, an antifoam, a wetting agent, fibres, a dye, a preservative, a further accelerator, a dispersion polymer, a cationic polymer, a cationic polycondensate, a cationic comb polymer, an air pore former, a further shrinkage reducer or a corrosion inhibitor or combinations thereof.

The plasticizer is in particular sodium gluconate, a lignosulfonate, a sulfonated naphthalene-formaldehyde condensate, a sulfonated melamine-formaldehyde condensate, a sulfonated vinyl copolymer, a polyalkylene glycol having phosphonate groups, a polyalkylene glycol having phosphate groups or an aromatic condensate having phosphonate groups and polyalkylene glycol chains.

The use of curing retarders can be advantageous since the processing time of the water-containing binder composition is increased thereby. The curing retarder is preferably a hydroxycarbonic acid, in particular tartaric acid, citric acid or gluconic acid, a sugar, in particular sucrose, a phosphate or a phosphonate, or their salts or mixtures thereof.

A preferred binder composition comprises or consists of:
from 10 to 50% by weight, preferably from 12 to 40% by weight, in particular from 15 to 35% by weight, of cement, in particular Portland cement,
from 0.1 to 5% by weight, preferably from 0.5 to 3% by weight, of calcium sulfoaluminate,
from 0 to 10% by weight, preferably from 0.1 to 5% by weight, of latent hydraulic binders, in particular metakaolin and/or silica dust,
from 45 to 85% by weight, preferably from 50 to 80% by weight, of mineral fillers,
from 0.1 to 2% by weight of at least one accelerator based on aluminium sulfate,
from 0.02 to 5% by weight of at least one polycarboxylate ether,
from 0.01 to 2% by weight of at least one rheological auxiliary,
from 0.01 to 1% by weight of at least one antifoam and
from 0 to 10% by weight of further additives,

based on the total weight of the dry binder composition.

The metered addition of the accelerator and of the polycarboxylate ether is preferably effected in such an amount that a binder composition which has been mixed with water remains readily mouldable for from a number of seconds to some minutes. As a result, the layers can be applied homogeneously, having good cohesion and the surface of the shaped body produced can, if desired, be after-treated, for example smoothed.

Mixing of the dry mineral binder composition with from 10 to 25% by weight, preferably from 12 to 22% by weight, more preferably from 14 to 20% by weight, of water and optionally from 0.01 to 2% by weight of polycarboxylate ether, based on the total weight of the dry binder composition, gives a water-containing mineral binder composition in the setting state which is optimal for the process.

Mixing with water is preferably carried out in a continuous mixer.

This ensures a high manufacturing speed. In addition, no material which has already been mixed in a discontinuous mixing apparatus has to be disposed of in the event of a possible interruption.

The strength development of the water-containing binder composition is advantageously determined before application. This helps to be able to set down the printing parameters and/or to adapt the binder composition, in particular the content of polycarboxylate ether in the dry and/or water-containing binder composition.

The setting of the water-containing binder composition advantageously commences after from about 10 minutes to 1 hour, and setting ends after a time of from about 30 minutes to 3 hours, measured in accordance with DIN EN 196-3 at 20° C. using an automatic Vicat apparatus.

The binder composition advantageously attains a strength of at least 0.05 MPa, preferably at least 0.08 MPa, in particular at least 0.1 MPa, after 1 hour after application, and at least 0.5 MPa, in particular 1 MPa, after 3 hours, preferably 2 hours. The strength can be determined by a penetration method, for example as described in ASTM C 403.

Such a strength development of the water-containing binder composition is particularly advantageous for efficient and homogeneous production of shaped bodies.

A further aspect of the present invention relates to the use of a system as described above for producing three-dimensional objects from curable building materials.

The curable building materials are preferably mineral binders or mineral binder compositions, in particular concrete and/or mortar compositions.

The objects produced can have virtually any desired shape. An object can, for example, be a building construction, a finished part for a building construction, a component, a masonry structure, a bridge, a column, a decorative element, for example artificial hills, reefs or sculptures, a basin, a well or a tub. Here, the shaped body can be a solid body or a hollow shape, with or without bottom.

Details and advantages of the invention will be described below with the aid of working examples and with reference to schematic drawings.

### BRIEF DESCRIPTION OF THE FIGURES

The figures show:

FIG. 1 a schematic depiction of an illustrative system for application of a building material;

FIG. 2 a schematic depiction of an illustrative mixer;

FIG. 3 a schematic depiction of an illustrative shaft module and drum module of a mixing chamber module;

FIG. 4 a depiction of a process using a system of the invention.

### WORKING EXAMPLES

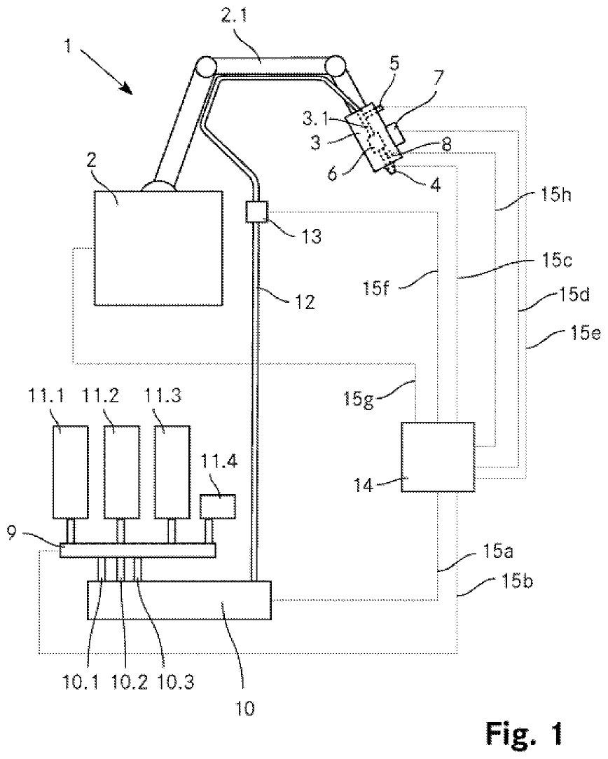

FIG. 1 schematically depicts an illustrative system 1 for application of a curable building material. The system 1 comprises a movement device 2 having a movable arm 2.1. At the free end of the arm 2.1, there is a printing head 3 which can be moved in all three directions in space by means of the arm 2.1. In this way, the printing head 3 can be moved to any position in the working range of the movement device 2.

The printing head 3 has, in its interior, a tubular passage 3.1 for conveying curable building material which runs from the end face facing the arm 2.1 (at the top in FIG. 1) through to the opposite and free end face. At the free end, the passage 3.1 opens into a controllable outlet 4 in the form of a nozzle which can be continuously opened and closed.

An inlet nozzle 5 for addition of an additive opens laterally into the passage 3.1 in a region facing the arm 2.1. An admixture, for example a rheological auxiliary, can if required, be added by means of the inlet nozzle 5 to the curable building material moving through the passage 3.1.

Furthermore, a static mixer 6 which additionally mixes the curable building material and the additive while it passes through the passage 3.1 is arranged in the passage 3.1 in the interior of the printing head 3 downstream of the inlet nozzle.

In addition, a measuring unit 8 for determining the pressure in the tubular passage 3.1 is arranged in the region of the controllable outlet 4. A scanning rate of the measuring unit 8 is, for example, 10 Hz.

In addition, a device 7 for deaerating the curable building material is installed on the printing head 3. The device is configured as vacuum treatment device and makes it possible to reduce the proportion of air in the curable building material. For this purpose, a section of the wall of the passage 3.1 can, for example, be configured as gas-permeable membrane, so that air is drawn from the curable building material when a subatmospheric pressure is applied outside the passage 3.1.

This system 1 for application of a curable building material additionally has a feed device 9 which communicates on the inlet side with three vessels 11.1, 11.2, 11.3 and an admixture reservoir 11.4. A component of the curable building material is present in each of the three vessels 11.1, 11.2, 11.3. The first component, which is present in the first vessel 11.1, comprises, for example, of cement and aggregates, by way of example sand and filler. The second component, which is present in the second vessel 11.2, consists, for example, of water. The third component present in the third vessel 11.3 is, for example, a plasticizer in the form of a polycarboxylate ether. In the admixture reservoir 11.4, there is, for example, a rheological auxiliary in the form of modified cellulose and/or a microbial polysaccharide.

On the outlet side, the feed device 9 has three separate outlets which are connected in each case to one of three inlets 10.1, 10.2, 10.3 of a mixing apparatus 10. The feed device 9 additionally has individually controllable metering devices (not shown in FIG. 1), so that the individual components in the individual vessels 11.1, 11.2, 11.3 can be metered individually into the mixing apparatus 10.

A further outlet of the feed device is connected to the inlet nozzle 5 (not shown in FIG. 1), so that admixture can be conveyed from the admixture reservoir 11.4 into the inlet nozzle 5 via a further metering device of the feed device 9.

The mixing apparatus 10 is configured as a dynamic mixer and comprises, apart from this, an integrated transport device in the form of a screw conveyor. In the mixing apparatus, the components which have been individually metered in are mixed with one another and conveyed into the flexible conduit 12 installed on the mixing apparatus on the outlet side. In operation, mixing and transport of the curable building material can be carried out continuously.

The curable building material can be conveyed through the flexible conduit 12, which opens on the end face of the printing head facing the arm 2.1 into the tubular passage 3.1, into the printing head 3 and be continuously applied through the controllable outlet 4.

Another constituent of the system 1 is a measuring unit 13 which is integrated into the transport conduit 12 in the region between the mixing apparatus 10 and the printing head 3. The measuring unit comprises, for example, an ultrasonic transducer which is configured for determining the flow properties of the curable material. A scanning rate of the measuring unit 13 is, for example, 10 Hz.

A central control unit 14 of the system 1 comprises a processor, a memory unit and a plurality of interfaces for receiving data and a plurality of interfaces for controlling individual components of the system 1.

The mixing apparatus 10 is connected via a first control line 15a to the control unit 14, while the feed device is connected via a second control line 15b to the control unit 14. In this way, the individual components in the vessels 11.1, 11.2, 11.3 can be metered into the mixing apparatus 10 by means of the central control unit according to prescribed formulations stored in the control unit and conveyed at adjustable transport rates into the flexible conduit 12.

The controllable outlet 4, the inlet nozzle 5 and the device 7 for deaeration of the curable building material at the printing head are each likewise connected via a separate control line 15c, 15d, 15e to the control unit 14 and can be controlled or monitored by the latter.

The movement device 2 is also connected to the control unit 14 via a further control line 15g. In this way, the movement of the printing head 3 can be controlled by the control unit 14.

The measuring unit 8 is connected by a data line 15h to the control unit 14 so that printing data measured in the measuring unit can be transmitted to the control unit 14.

Analogously, the measuring unit 13 is connected by a data line 15f to the control unit 14 so that data which characterize the flow properties and have been measured in the measuring unit can be transmitted to the control unit 14.

The control unit 14 is, for example, programmed so that:
(i) the addition rates of the three components of the curable building material are controlled by means of the feed device 9 as a function of the flow properties of the curable building material in the flexible conduit determined by means of the measuring unit 13;
(ii) the transport device integrated into the mixing apparatus 10 is controlled as a function of the pressure 8 determined by means of the measuring unit 8 and also the structure of the object to be produced using the curable building material;
(iii) the addition rate of the additive through the inlet nozzle 5 is controlled as a function of the flow properties of the curable building material determined by means of the measuring unit 13 and also the structure of the object to be produced;
(iv) the degree of deaeration of the curable building material in the device 7 is controlled as a function of the flow properties of the curable building material determined by means of the measuring unit 13;
(v) the movement device 2 and thus the position of the printing head 3 is controlled as a function of a model of the object to be produced stored in the data store of the control unit 14.

The dry mineral binder composition used as first component has, for example, the composition described in Table 1.

TABLE 1
Composition of the dry binder composition

| Component | % by weight in the binder composition |
|---|---|
| Cement CEM I 52.5 | 25 |
| Metakaolin | 4.5 |
| Betoflow ® D | 5 |
| Nekafill ® 15 | 20 |
| Sand 0-1 mm | 42 |
| Denka CSA #20 | 2 |
| Sika ® ViscoCrete ®-225P | 0.25 |
| Carbowet ® 4000 | 0.5 |
| Modified cellulose | 0.05 |
| Inorganic thickener | 0.10 |
| Superabsorbent | 0.1 |
| Aluminium sulfate | 0.5 |

The following materials were used here:
Aluminium sulfate is Al₂(SO₄)₃.18H₂O, obtainable from Merck, Switzerland.
Betoflow® D is a fine calcium carbonate powder having a particle size of 1-5 μm, obtainable from Omya.
Nekafill® 15 is a ground limestone, obtainable from Kalkfabrik Netstal.
Sika® ViscoCrete®-225P is a pulverulent superplasticizer based on a polycarboxylate ether, obtainable from Sika.
Carbowet® 4000 is an antifoam, obtainable from Air Products Chemicals Europe.
Denka CSA #20 is a shrinkage reducer based on calcium sulfoaluminate cement, obtainable from Newchem, Switzerland.

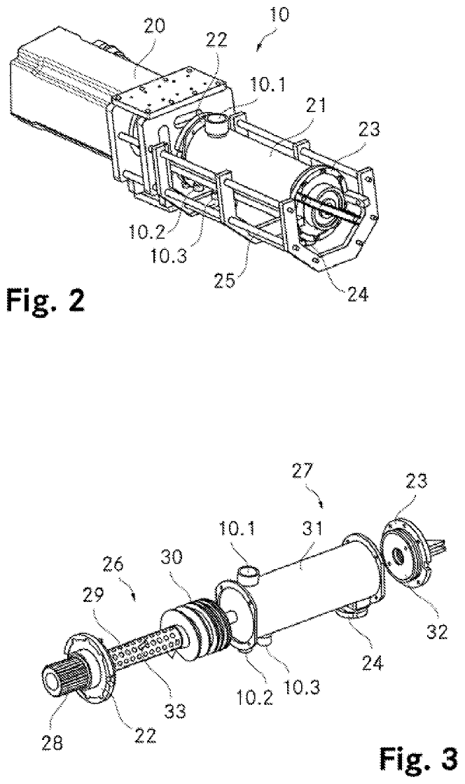

FIG. 2 depicts an illustrative embodiment of the mixing apparatus 10 of FIG. 1. The mixing apparatus 10 comprises a drive 20, a drum 21, a proximal closure 22, a distal closure 23, an outlet 24, a first inlet 10.1, a second inlet 10.2, a third inlet 10.3 and a support device 25.

In this working example, the distal closure 23 is joined via the support device 25 to the drive 20, so that a stirrer shaft (not visible in this image) can be mounted on bearings both in the proximal closure 22 and in the distal closure 23.

When the mixing apparatus 10 is being used, the first component is, for example, fed in through the first inlet 10.1, the second component is fed in through the second inlet 10.2 and the third component is fed in through the third inlet 10.3.

FIG. 3 shows the mixing apparatus 10 without the drive module 20 in a disassembled state. In this working example, the mixing apparatus 10 comprises a shaft module 26 and a drum module 27.

The shaft module 26 comprises a coupling element 28 for mechanical coupling to the drive unit 20, the proximal closure 22, a stirrer shaft 29 and a transport element 30.

In this working example, the drum module 27 comprises a one-piece tubular drum 31 and also a distal closure 23. The drum 31 has a first inlet 10.1, a second inlet 10.2 and a third inlet, 10.3, which are all arranged in a first end region of the drum 31. The outlet 24 is arranged on a second end region of the drum 31.

The distal closure 23 has, in this working example, a sacrificial plate 32 which is arranged on one side of the distal closure 23 which faces the drum 31. The sacrificial plate 32 is worn away during operation of the system and can be replaced when required. This enables the distal closure 23 to be used over a longer period of time.

The transport element 30 is in this working example configured as transport screw. Here, the transport element 30 is arranged such that it can be plugged onto the stirrer shaft 29. In addition, the transport element 30 is secured to the stirrer shaft 29 by a locking element (not visible on this image).

In the region of the shaft module 26, pins 33 which project radially from the stirrer shaft 29 are additionally attached as stirring elements (only a single pin is shown in FIG. 3).

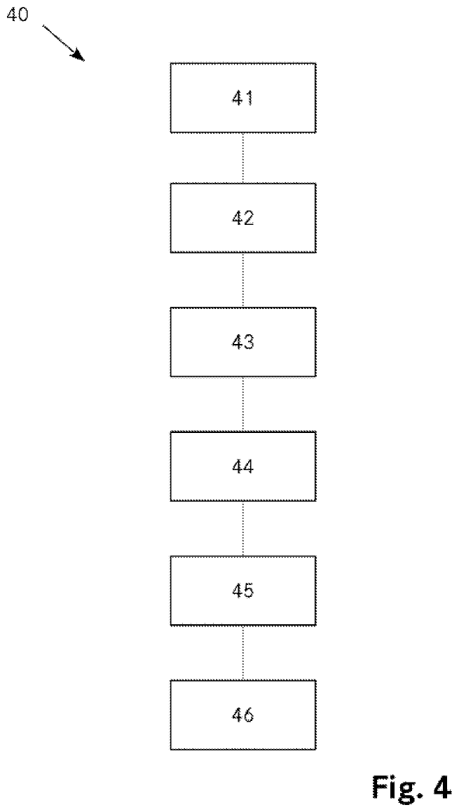

FIG. 4 shows a process using the system 1 of the invention. In a first step 41, the dry mineral binder composition from Table 1 (see above) is provided as first component in the vessel 11.1. Water as second component is placed in vessel 11.2 and a plasticizer as third component is placed in vessel 11.3.

The components are then, in the second step 42, introduced continuously by means of the feed device 9 into the mixing apparatus 10 and mixed with one another there in the next step 43 to give a mineral binder composition mixed with water. The dry binder composition having the composition indicated in Table 1 is mixed in the mixing apparatus 10 with such an amount of water that a weight ratio of water to dry binder composition of about 0.16 is obtained. The plasticizer is metered in in such an amount that a prescribed yield point is achieved. The mineral binder composition which has been mixed with water corresponds to a curable building material in the setting state.

The binder composition which has been mixed with water is subsequently fed, in the fourth step 44, by means of the screw conveyor integrated into the mixing apparatus 10 via the transport conduit 12 to the printing head 3.

During feeding to the printing head 3, an admixture in the form of a rheological auxiliary, for example a modified cellulose and/or a microbial polysaccharide, is, in step 45, added in a metered manner via the inlet nozzle 5 to the made-up binder composition as a function of the flow properties of the binder composition determined by means of the measuring unit 13 and/or the binder composition is deaerated by means of the device 7.

The chemical and/or physical properties are thus adapted when required so that prescribed intended values for the flow properties are adhered to.

The layerwise application of the binder composition via the outlet 4 of the printing head is subsequently carried out in step 46, so as to produce the object to be made.

All steps in the process 40 including control of the printing head are controlled and monitored by means of the control unit 14.

Specifically, a tube having a height of 2 m and a diameter of about 600 mm was produced as example. The individual layers applied had a width of about 30 mm and a height of about 10 mm. The horizontal speed of the printing head was about 40 mm per second. The printing of the shaped body took 2 hours and 40 minutes. The height of the lower layers and of the upper layers differed by not more than 5%. The printed shaped body had a corrugated, very uniform surface without visible defects. Even after storage for 3 days at 25° C. and about 40% relative atmospheric humidity, the shaped body did not display any visible cracks. About 16 hours after application of the last layer, the hollow body was lifted with the aid of carrying straps and a crane onto a transport pallet without damage to the printed shaped body occurring.

After about 4 days, the shaped body was destroyed by means of a heavy hammer and the fragments were analyzed visually. The fracture surfaces had a uniform surface, without air inclusions or defects. The fracture surfaces did not display any preferential orientation, i.e. the applied layers had equally good bonding between one another as within the same layer.

The above-described embodiments should be interpreted merely as illustrative examples which can be modified as desired within the scope of the invention.

Thus, for example, the static mixer 6 can be omitted, so that neither a static mixer nor a dynamic mixer is present in the printing head.

In addition to or instead of the transport device integrated into the mixing apparatus 10, one or more further transport devices can be provided in the transport conduit 12 and/or in the printing head 3. It is also possible for transport devices other than transport screws to be present.

It is likewise possible for other measuring units which allow, for example, a temperature measurement to be provided instead of or in addition to the measuring units 8, 13 in the region of the printing head 3 and/or in the transport conduit 12. It is also conceivable for the measuring unit 13 in the transport conduit to be completely omitted or to be integrated in the printing head.

The mixing apparatus 10 can also have fewer or more inlets, so that additional components which are present in additional vessels can be metered in.

Instead of one or more of the vessels 11.1, 11.2, 11.3, it is also possible for connections to external sources, e.g. a water connection, to be present.

It is also possible to program the control unit differently, for example so that a volume flow through the transport conduit 12 and/or the printing head 3 is taken into account.

### LIST OF REFERENCE NUMERALS

1 System
2 Movement device
2.1 Movable arm
3 Printing head
3.1 Passage
4 Controllable outlet
5 Inlet nozzle
6 Static mixer
7 Deaeration device
8 Pressure measuring unit
9 Feed device
10 Mixing apparatus
10.1 First inlet
10.2 second inlet
10.3 Third inlet
11.1 First vessel
11.2 Second vessel
11.3 Third vessel
11.4 Admixture reservoir
12 Flexible conduit
13 Measuring unit with ultrasonic transducer
14 Control unit
15a . . . h Control and data powers
20 Drive
21 Drum
22 Proximal closure
23 Distal closure
24 Outlet
25 Support device
26 Shaft module
27 Drum module
28 Coupling element
29 Stirrer shaft
30 Transport element
31 Drum
32 Sacrificial plate
33 Pins (stirring elements)
40 Application process
41 . . . 46 Process steps

1. A system for application of a curable building material, the system comprising:
a mixing apparatus for mixing individual components of the curable building material to give a curable building material in the setting state;
a printing head which is movable in at least one direction in space and by means of which setting building material can be applied;
a transport conduit by means of which setting building material can be conveyed from the mixing apparatus to the printing head;
at least one transport device for transporting setting building material from the mixing apparatus through the transport conduit to the printing head;
a feed device which is configured so that at least two separate components of the curable building material can be introduced via at least two separate inlets into the mixing apparatus.

2. The system according to claim 1, wherein the mixing apparatus is not arranged on the movable printing head and/or no mixing apparatus is arranged on the movable printing head.

3. The system according to claim 1, wherein the mixing apparatus comprises a dynamic mixer and a static mixer.

4. The system according to claim 1, wherein there is an inlet nozzle for admixing an additive to the setting building material in the transport conduit and/or in the region of the printing head.

5. The system according to claim 1, wherein there is an apparatus for aerating and/or deaerating the setting building material.

6. The system according to claim 1, wherein there is an apparatus for changing the temperature of the setting building material.

7. The system according to claim 1, wherein there is a measuring unit for determining a chemical and/or physical property of the setting building material in the mixing apparatus, in the transport conduit, in the printing head and/or after the delivery from the printing head.

8. The system according to claim 7, wherein the measuring unit is designed so that the determination of the chemical and/or physical property can be carried out during application of the building material.

9. The system according to claim 1, wherein an outlet which is controllable in respect of the size of the through-opening is present on the printing head.

10. The system according to claim 1, wherein a control unit is present.

11. The system according to claim 10, wherein the control unit is configured so that the transport power of the transport device is or can be controlled and/or regulated on the basis of a chemical and/or physical property of the curable building material determined using the measuring unit.

12. The system according to claim 10, wherein the control unit is configured so that an addition rate of at least one component of the curable building material by means of the feed device is or can be regulated as a function of the chemical and/or physical property of the curable building material.

13. The system according to claim 1, wherein:
a first component of the building material is present in solid form and comprises a mineral binder and optionally aggregates;
a second component of the building material is present in liquid form and comprises water;
an optional third component comprising a plasticizer is present;
an admixture which can be added via the inlet nozzle;
where the components and optionally the admixture are present in vessels which are spatially separated from one another and are constituents of the feed device and/or communicate with the latter.

14. The system according to claim 13, wherein the first component comprises a dry mineral binder composition comprising cement and mineral fillers, where the binder composition comprises at least one setting accelerator based on aluminium sulfate, at least one superplasticizer based on a polycarboxylate ether and at least one rheological auxiliary, where the polycarboxylate ether has at least 1 mmol, of carboxylic acid groups per gram of dry polycarboxylate ether.

15. A method for producing three-dimensional objects from curable building materials, comprising printing a three-dimensional object suing the system according claim 1.
